(19) United States
(12) Patent Application Publication
(10) Pub. No.: US 2026/0259717 A1
(43) Pub. Date: Sep. 3, 2026

(54) RECURRENT LEARNING FOR CODE TRANSLATION

(71) Applicant: INTERNATIONAL BUSINESS MACHINES CORPORATION, Armonk, NY (US)

(72) Inventors: Rangeet Pan, White Plains, NY (US); Rahul Krishna Prasad, White Plains, NY (US); Saurabh Sinha, Danbury, CT (US); Michele Merler, New York, NY (US); Venkata Nagaraju Pavuluri, New Rochelle, NY (US); Maja Vukovic, New York, NY (US)

(21) Appl. No.: 19/068,795

(22) Filed: Mar. 3, 2025

(51) Int. Cl. G06F 8/51; G06F 8/35; G06F 8/77; G06N 3/092

(52) U.S. Cl. CPC G06F 8/51; G06F 8/35; G06F 8/77; G06N 3/092

(57) ABSTRACT

Embodiments receive at least one source code from an external application; compute a first code readability and a first code complexity of the at least one source code and a second code readability and a second code complexity of an intermediate code; build a reward model based on the first code readability and the first code complexity of the at least one source code and the second code readability and the second code complexity of the intermediate code; train the reward model by utilizing a reinforcement learning (RL) algorithm; translate the at least one source code by utilizing a code compiler and the trained reward model; and output at least one target code based on the translated at least one source code.

### BACKGROUND

Aspects of the present invention relate generally to a system and a method for providing a recurrent learning based approach for translating code from one language to another.

Code translation occurs when code written in a source language is translated to a target language. One key feature of code translation is code readability, which is how easy the code is to understand, maintain, and modify. Another key feature of code translation is code optimization, which is the process of modifying the code to improve runtime performance of the code.

### SUMMARY

In a first aspect of the invention, there is a method including: receiving at least one source code from an external application; computing a first code readability and a first code complexity of the at least one source code and a second code readability and a second code complexity of an intermediate code; building a reward model based on the first code readability and the first code complexity of the at least one source code and the second code readability and the second code complexity of the intermediate code; training the reward model by utilizing a reinforcement learning (RL) algorithm; translating the at least one source code by utilizing a code compiler and the trained reward model; and outputting at least one target code based on the translated at least one source code.

In another aspect of the invention, there is a computer program product including one or more computer readable storage media and program instructions stored on the one or more computer readable storage media to perform operations including: receiving at least one source code from an external application; computing a first code readability and a first code complexity of the at least one source code and a second code readability and a second code complexity of an intermediate code; building a reward model based on the first code readability and the first code complexity of the at least one source code and the second code readability and the second code complexity of the intermediate code; training the reward model by utilizing a reinforcement learning (RL) algorithm; translating the at least one source code by utilizing a code complier and the trained reward model; and outputting at least one target code based on the translated at least one source code.

In another aspect of the invention, there is a system including a processor set, one or more computer readable storage media, and program instructions stored on the one or more computer readable storage media to cause the processor set to perform operations including: receiving at least one source code from an external application; computing a first code readability and a second code complexity of the at least one source code and a first code readability and a second code complexity of an intermediate code; building a reward model based on the first code readability and the first code complexity of the at least one source code and the second code readability and the second code complexity of the intermediate code; training the reward model by utilizing a reinforcement learning (RL) algorithm; translating the at least one source code by utilizing a code compiler and the trained reward model; and outputting at least one target code based on the translated at least one source code. In further embodiments, the at least one target code comprises optimized code which is optimized for the first code readability, the second code readability, the first code complexity, and the second code complexity.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows examples of code readability metrics of an exemplary method in accordance with aspects of the present invention.

FIG. 5 shows another example of code readability metrics of an exemplary method in accordance with aspects of the present invention.

FIG. 6 shows examples of code complexity metrics of an exemplary method in accordance with aspects of the present invention.

FIG. 7 shows a block diagram of a computation of code readability and complexity in accordance with aspects of the present invention.

FIG. 8 shows a block diagram of building a reward model in accordance with aspects of the present invention.

FIG. 9 shows a block diagram of deploying a reinforcement agent in accordance with aspects of the present invention.

### DETAILED DESCRIPTION

Aspects of the present invention relate generally to a system and a method for providing a recurrent learning based approach for translating code from one language to another. In aspects of the present invention, the translation code from one language to another optimizes both the code readability and the code complexity. In further embodiments, the system and the method optimizes the translated code by building, training, and deploying a reward model using a reinforcement learning (RL) algorithm to improve the code readability and code complexity.

Embodiments of the present invention provide a system, a computer program product, and a computer-implemented method for providing a recurrent learning agent to increase code readability. In particular, aspects of the present invention provide a system, a computer program product, and a computer-implemented method to apply reinforcement learning on an optimization process while generating an intermediate representation. In further aspects of the present invention, the computer-implemented method creates a code readability metric that is tuned toward code translation. Embodiments of the present invention build a reinforcement learning agent using code optimization and source code readability metrics. Further embodiments of the present invention build and apply a trained model to tune a code optimization process to generate more human writable code (i.e., code with improved code readability).

Embodiments of the present invention modernize an application by improving code translation between source code and target code. Embodiments of the present invention generate human readable code by automatically converting source code from one language to another while ensuring that the target code is similar to a developer written code. Embodiments of the present invention reduce maintenance by generating code that preserves key essentials of the source code to aid an application maintenance.

Embodiments of the present invention optimize generated code by removing redundant sections of the code while performing code translation. Implementations of the present invention generate code that is very similar to what a human developer would write in a source programming language. Aspects of the present invention generate a recurrent learning based approach that guides optimization tasks of the source code translator. Implementations of the present invention provide a reinforcement learning agent that is rewarded based on various metrics that track how a human developer would write code and readable code characteristics.

Aspects of the present invention improve code readability by surveying existing literatures regarding natural code characteristics. Embodiments of the present invention also provide a trained model which assists a source code translator to provide a code optimization process and generates readability code.

Embodiments of the present invention generate human readable code while translating from one language to another. For example, a computer-implemented method includes: building a reinforcement learning model by building a reward function and formalizing the states, action space, transition function, and policies; computing the code readability and complexity; building the reward model; training the reinforcement agent; and deploying the trained reinforcement agent. The computer-implemented method further includes: building the reward function by defining code readability; and defining the code optimization measuring metric. The computer-implemented method also further includes: training the reinforcement agent by treating each basic block in a source program as a single state; performing, at each state, one or more of common sub-expression elimination, constant propagation, copy propagation, and dead code removal; denoting the probability of transition to state s′ after taking action a on state s; and creating the reward function based on the readability metrics. In embodiments, the state s represents a current situation about an environment at a given time, an action a represents a decision taken within the state s′, and the state s′ represents a next state that the environment transitions to after taking the action a in state s.

Conventional systems include compiler-related processes that are built to optimize source code during code translation to increase performance execution. Accordingly, conventional systems have limitations which prevent a code translation to a target code from resembling the source code or having a similar logic as the source code. In other words, conventional systems focus on optimizing code while sacrificing code readability. In contrast, embodiments of the present invention provide a computer-implemented method, a system, and a computer program product for tuning a code optimization process to generate a target code which is more similar to the source code and has improved code readability. Embodiments of the present invention provide a recurrent learning based approach that guides optimization tasks of a source code translator. Further, aspects of the present invention provide a trained model that helps the source code translator to guide the optimization process to improve code readability of the target code.

Embodiments of the present invention include a system, method, and computer program product for improving code readability during a code translation process. Accordingly, implementations of the present invention provide an improvement (i.e., technical solution) to a problem arising in the technical field of code translation. In particular, embodiments of the present invention improve application maintenance by translating code from a source code to an optimized target code which is similar to the source code.

Implementations of the present invention are necessarily rooted in computer technology. For example, the steps of building a reward model based on a first code readability and a first code complexity of the at least one source code and a second code readability and a second code complexity of an intermediate code, training the reward model by utilizing a reinforcement learning (RL) algorithm, and translating the at least one source code by utilizing a code compiler and the trained reward model cannot be performed in the human mind (or with pen and paper). Building a reward model based on the first code readability and the first code complexity of the at least one source code and the second code readability and the second code complexity of the at least one intermediate code, training the reward model by utilizing a reinforcement learning (RL) algorithm, and translating the at least one source code by utilizing a code compiler and the trained reward model is, by definition, performed by a computer and cannot be performed in the human mind (or with a pen and paper) due to the complexity and amounts of calculations involved in translating the at least one source code to the at least one target code based on a reward model by utilizing a reinforcement learning (RL) algorithm. Implementations of the present invention are also rooted in computer technology by determining a set of code readability metrics by utilizing a convolutional neural network (CNN).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as recurrent learning code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

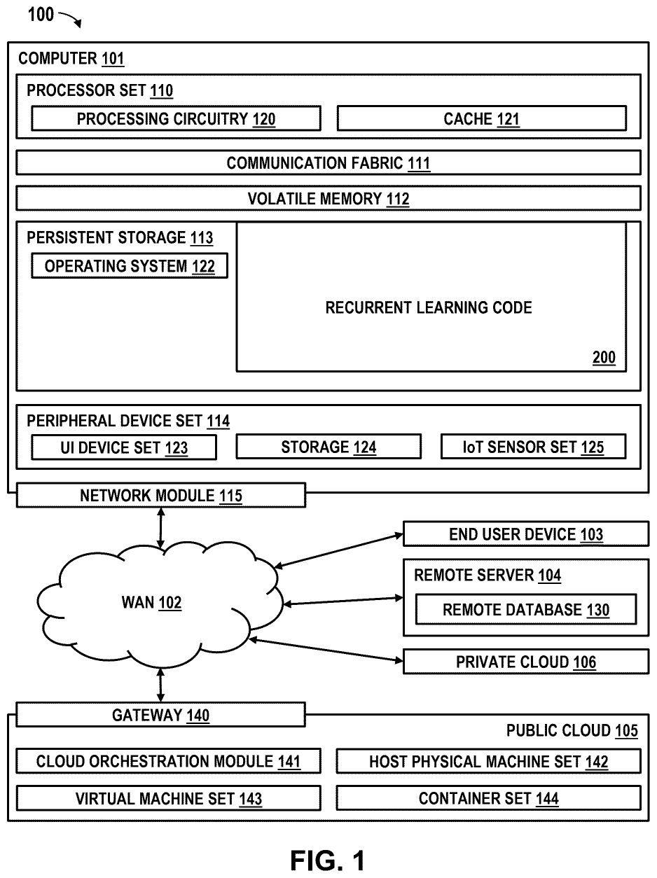

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

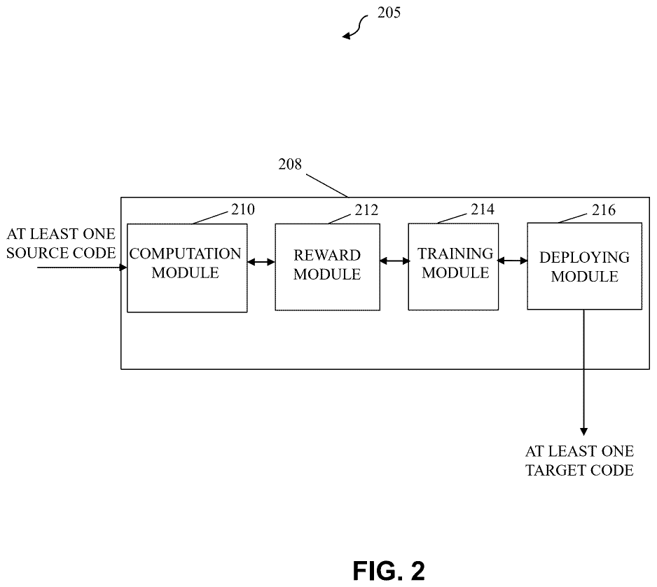

FIG. 2 shows a block diagram of an exemplary environment 205 in accordance with aspects of the present invention. In embodiments, the environment 205 includes a recurrent learning server 208, which may comprise one or more instances of the computer 101 of FIG. 1. In other examples, the recurrent learning server 208 comprises one or more virtual machines or one or more containers running on one or more instances of the computer 101 of FIG. 1.

In embodiments, the recurrent learning server 208 of FIG. 2 comprises a computation module 210, a reward module 212, a training module 214, and a deploying module 216, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The recurrent learning server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the computation module 210 receives at least one source code from an external application. In embodiments, the external application comprises any software application which is external to the recurrent learning server 208. In further embodiments of the present invention, the computation module 210 uses a compiler with an intermediate representation (IR) to generate an intermediate code. In aspects of the present invention, the intermediate code is a translation of the at least one source code to a form which is more suitable for optimization and translation. In embodiments of the present invention, the computation module 210 computes the code readability and code complexity of the at least one source code and the intermediate code. In further embodiments, the computation module 210 computes the code readability of the at least one source code and the intermediate code based on a weighted average of code readability metrics. In aspects of the present invention, the code readability metrics may include the number of nested blocks, the number of parameters, the number of statements, the number of blank lines, the number of assignments, the number of characters, the number of commas, the number of comments, the number of comparisons, the number of conditionals, the number of identifiers, the number of keywords, the number of literals, the number of loops, the number of numbers, the number of operators, the number of parenthesis, the number of periods, the number of spaces, the number of strings, the number of words, the indentation length, the identifier length, the line length, etc. In aspects of the present invention, the computation module 210 determines and classifies readability metrics based on a convolutional neural network (CNN). For example, the CNN may be used for readability metrics by processing text as if it were an image, allowing the network to learn complex patterns within the text to identify features that contribute to readability level, such as sentence structure, word complexity, and overall coherence to predict how easy a given text is to understand to assess a readability level.

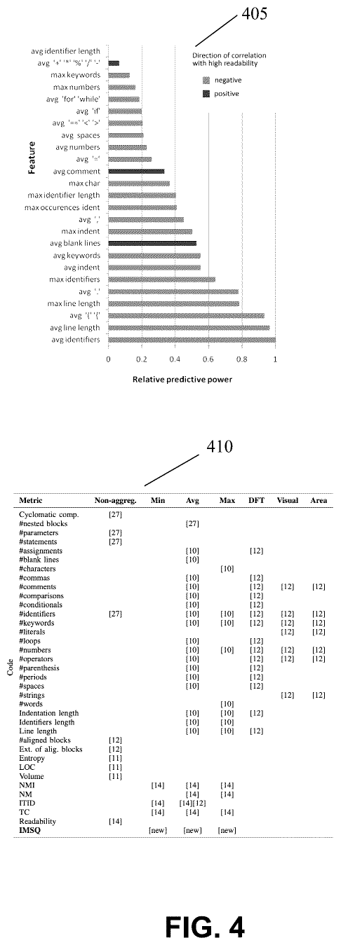

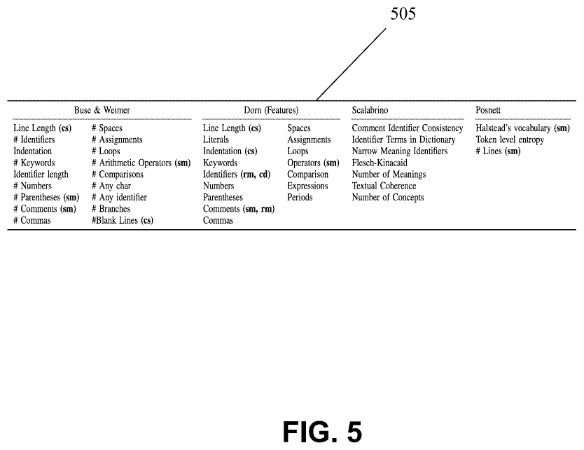

In further embodiments, a full list of the code readability metrics is shown in FIGS. 4 and 5. In an example, the computation module 210 computes the code readability using Equation 1 below:

$$Code Readability for Code = wR 1 * Metric1 - wR 2 * Metric2 + wR 3 * Metric3 + … . \qquad ( Equation 1 )$$

In Equation 1 above, wR1 is a positive weight which increases the code readability for Metric1, wR2 is a negative weight which decreases the code readability for Metric2, and wR3 is a positive weight which increases the code readability for Metric3.

In further embodiments, the computation module 210 computes the code complexity of the at least one source code and the intermediate code based on a weighted average of code complexity metrics. In aspects of the present invention, the code complexity metrics may include McCabe, Halstead, lines of code, error count, object oriented class metrics, software package metrics, cohesion, coupling, etc. In embodiments of the present invention, McCabe measures the complexity of a code program by counting the decision points. In further embodiments, Halstead measures the complexity of the code program based on the number of operands and operators. In aspects of the present invention, cohesion measures the complexity of a code program by determining a strength of a relationship between class methods and data. In an example, the computation module 210 computes the code complexity using Equation 2 below:

$$Code Complexity for Code = wC 1 * McCabe - wC 2 * Halstead + wC 3 * Cohesion3 + … . \qquad ( Equation 2 )$$

In Equation 2 above, wC1 is a positive weight which increases the code complexity for McCabe, wC2 is a negative weight which decreases the code complexity for Halstead, and wC3 is a positive weight which increases the code complexity for Cohesion3. In embodiments of the present invention, the computation module 210 determines a first delta (i.e., a difference) between the computed code complexity of the at least one source code and the computed code complexity of the intermediate code. In further embodiments of the present invention, the computation module 210 determines a second delta (i.e., the difference) between the computed code readability of the at least one source code and the computed code readability of the intermediate code. The computation model 210 sends the at least one source code, the computed code complexity of the at least one source code, the computed code complexity of the intermediate code, the computed code readability of the at least one source code, the computed code readability of the intermediate code, the first delta, and the second delta to the reward module 212.

In embodiments, the reward module 212 builds a reward model with a reward function. receives. In aspects of the present invention, the reward module 212 builds the reward model with the reward function based on the weights (e.g., wR1, wR2, wR3, wC1, wC2, and wC3) and the metrics (e.g., Metric1, Metric2, and Metric3) from the computation module 210 from the computation model 210. In aspects of the present invention, the reward function is determined at each move of the translation of the at least one source code. In particular, the reward module 212 determines the reward function using Equation 3 below:

$$Reward Function = ( wR 1 * Metric1 - wR 2 * Metric2 + wR 3 * Metric3 + … ) - ( wC 1 * McCabe - wC 2 * Halstead + wC 3 * Cohesion3 + … ) . \qquad ( Equation 3 )$$

In further embodiments, the reward model is initialized with initial weights wR1, wR2, wR3, wC1, wC2, wC3, etc., and an initial target value of the reward function. In aspects of the present invention, the reward module 212 sends the at least one source code, the computed code complexity of the at least one source code, the computed code complexity of the intermediate code, the computed code readability of the at least one source code, the computed code readability of the intermediate code, the first delta, the second delta, and the reward function to the training module 214 for training the reward model.

In embodiments of the present invention, the training module 214 trains the reward model by utilizing a reinforcement learning (RL) algorithm. In aspects of the present invention, the RL algorithm utilizes a reinforcement agent to takes actions in an environment. The actions in the environment are interpreted into a reward function and a state such that the reward function and the state are fed back to the reinforcement agent for continuous and real-time improvement. In further aspects of the present invention, a transition model predicts what the environment does next and gives an effect of an action in a state. In embodiments, each block in the at least one source code is treated as a single state. Accordingly, each block in the at least one source code is connected by the data, control, and other dependencies. In further embodiments, a first basic block (i.e., B₀) of the at last one source code comprises a first initial step.

In aspects of the present invention, at each state, there are a finite number of actions a. For instance, actions a can include common sub-expression elimination, constant propagation, copy propagation, and dead code removal. In embodiments, sub-expression elimination is a compiler optimization technique that identifies and removes redundant calculations within a program by replacing identical sub-expressions with a single variable. In further embodiments, constant propagation is a compiler optimization technique that replaces known constants with their values in expressions. In aspects of the present invention, copy propagation is a compiler optimization technique that is used to replace the occurrence of target variables of direct assignments with their values. In further aspects of the present invention, dead code removal is a compiler optimization technique that is used to remove code that does not affect program results.

In further embodiments of the present invention, the transition model includes a transition probability T(s′|(s,a)), which denotes a probability of transition to state s′ after taking action a on state s. In further embodiments, with every transition, the transition model verifies whether the transition probability ended with the same state. In aspects of the present invention, the action a is not a valid action in response to the transition probability ending with the same state. One example of the transition probability ending with the same state is dead code removal.

In aspects of the present invention, the optimal policy of the state s of the reinforcement agent can be determined using Equation 4 below:

$$Optimal policy ( s ) = arg max {\sum }_{a ∈ A ( s ) , {s}^{′}} T ( {s}^{′} \vert s , a ) R ( {s}^{′} ) \sum T . \qquad ( Equation 4 )$$

In further embodiments, the training module 214 utilizes the reinforcement agent to train the reward model using the RL algorithm. In aspects of the present invention, the training module 214 trains the reward model by communicating with the reward model 212 for receiving the determined reward function. The training module 214 sends the at least one source code, the computed code complexity of the at least one source code, the computed code complexity of the intermediate code, the computed code readability of the at least one source code, the computed code readability of the intermediate code, the first delta, the second delta, the reward function, the trained reward model, and the reinforcement agent to the deploying module 216.

In aspects of the present invention, the deploying module 216 deploys the reinforcement agent and the trained reward model to translate the at least one source code. In further embodiments of the present invention, the deploying module 216 utilizes the reinforcement agent which comprises a compiler to convert the at least one source code into an abstract syntax tree (AST). In further embodiments, the AST abstracts away details of the at least one source code and retains enough information for the compiler to understand a structure of the at least one source code. The deploying module 216 sends the AST to the trained reward model which guides the optimization process to output a target value of the reward function. The deploying module 216 sends the target value of the reward function to the compiler with the intermediate representation (IR) to output at least one target code. Accordingly, the at least one target code comprises optimized code which is optimized for both code readability and code complexity based on the trained reward model.

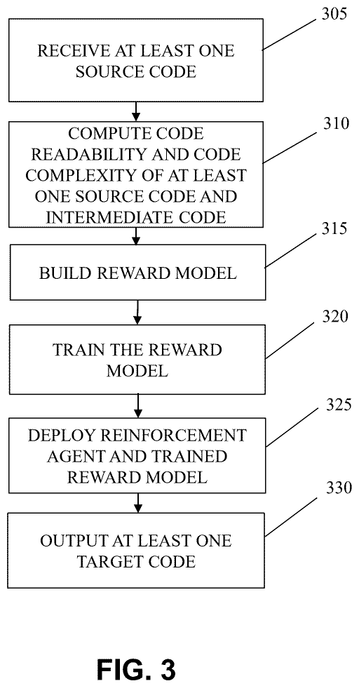

FIG. 3 shows a flowchart of an exemplary method in accordance with aspects of the present invention. Steps of the method may be carried out as operations in the environment 205 of FIG. 2 and are described with reference to elements depicted in FIG. 2.

At step 305, the system receives, at the computation module 210, at least one source code from an external application. In embodiments and as described with FIG. 2, the external application comprises a software application. At step 310, the system computes, at the computation module 210, code readability and code complexity of the at least one source code and an intermediate code. In embodiments and as described with FIG. 2, the computation module 210 uses a compiler with an intermediate representation (IR) to generate the intermediate code.

At step 315, the system builds, at the reward module 214, a reward model with a reward function. In embodiments and as described with FIG. 2, the reward module 214 determines the reward function by subtracting the code complexity from the code readability. At step 320, the system trains, at the training module 214, the reward model by utilizing a reinforcement learning (RL) algorithm with a reinforcement agent. In embodiments and as described with FIG. 2, the reinforcement agent takes actions in an environment, which is interpreted into the reward function and a state, which are fed back to the reinforcement agent.

At step 325, the system deploys, at the deploying module 216, the reinforcement agent comprising a code compiler and the trained reward model to translate the at least one source code. In embodiments and as described with FIG. 2, the deploying module 216 utilizes the trained reward model to guide an optimization process. At step 330, the system outputs, at the deploying module 216, at least one target code by utilizing the trained reward model. In embodiments and as described with FIG. 2, the at least one target code comprises optimized code which is optimized for both code readability and code complexity based on the trained reward model.

FIG. 4 shows examples of code readability metrics of an exemplary method in accordance with aspects of the present invention. In embodiments, FIG. 4 shows a first table 405 which includes code readability metrics (i.e., features) mapped against relative predictive power. For example, in the first table 405, the code readability metrics such as average line length and average identifiers have the highest relative predictive power. In further embodiments, FIG. 4 shows a second table 410 which includes further code readability metrics. FIG. 5 shows another example of code readability metrics of an exemplary method in accordance with aspects of the present invention. In embodiments, FIG. 5 shows a third table 505 which includes other code readability metrics. As discussed above, the computation module 210 determines and classifies readability metrics of the tables 405, 410, and 505 based on a convolutional neural network (CNN).

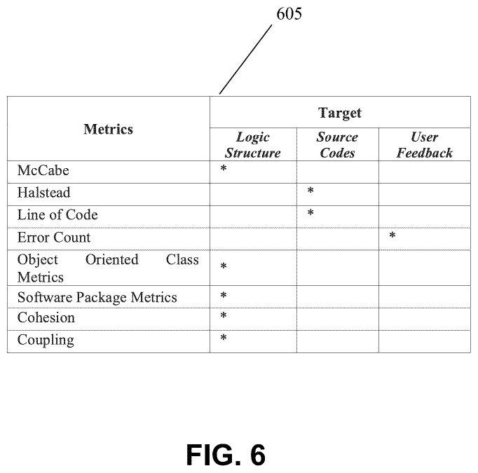

FIG. 6 shows examples of code complexity metrics of an exemplary method in accordance with aspects of the present invention. In aspects of the present invention, FIG. 6 shows a fourth table 605 which includes code complexity metrics including McCabe, Halstead, Line of Code, Error Count, Object Oriented Class Metrics, Software Package Metrics, Cohesion, and Coupling.

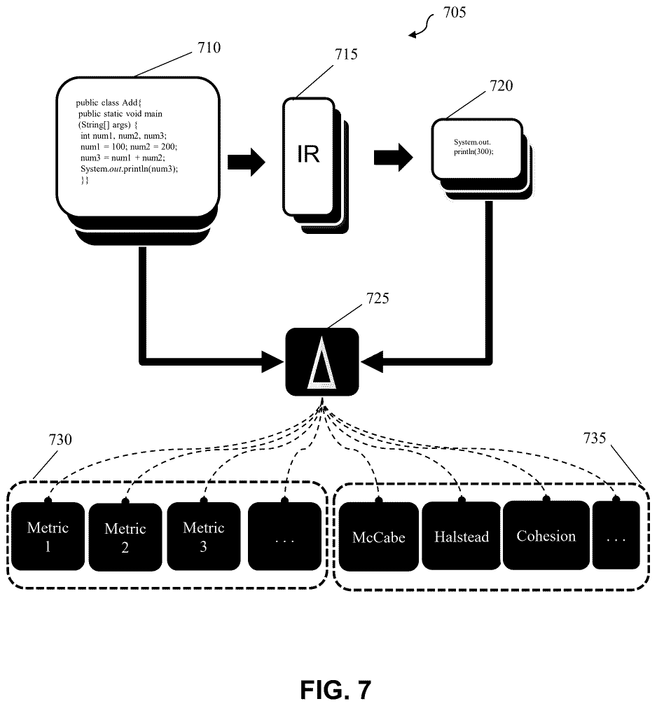

FIG. 7 shows a block diagram of a computation of code readability and complexity in accordance with aspects of the present invention. In FIG. 7, the block diagram 705 includes at least one source code 710, an intermediate representation (IR) 715, an intermediate code 720, a delta 725, a set of code readability metrics 730, and a set of code complexity metrics 735. In the block diagram 705, a computation module 210 receives the at least one source code 710 and uses a compiler with the IR 715 to convert the at leas one source code 710 to the intermediate code 720. The computation module 210 then utilizes the set of code readability metrics 730 and the set of code complexity metrics 735 to compute the code readability and the code complexity of the at least one source code 710 and the intermediate code 720. The computation module 210 determines a first delta (i.e., subtraction) between the computed code complexity of the at least one source code 710 and the computed code complexity of the intermediate code 720. The computation module 210 determines a second delta (i.e., subtraction) between the computed code readability of the at least one source code 710 and the computed code readability of the intermediate code 720.

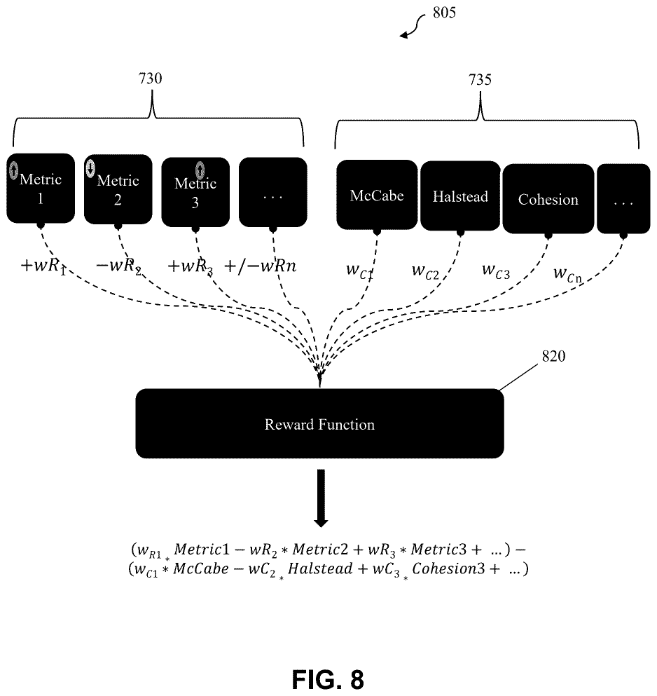

FIG. 8 shows a block diagram of building a reward model in accordance with aspects of the present invention. In FIG. 8, the block diagram 805 includes the set of code readability metrics 730, the set of code complexity metrics 735, and a reward function 820. In embodiments of the block diagram 805, the reward function 820 comprises a weighted average of the set of code complexity metrics 735 which is subtracted from a weighted average of the set of code readability metrics 730.

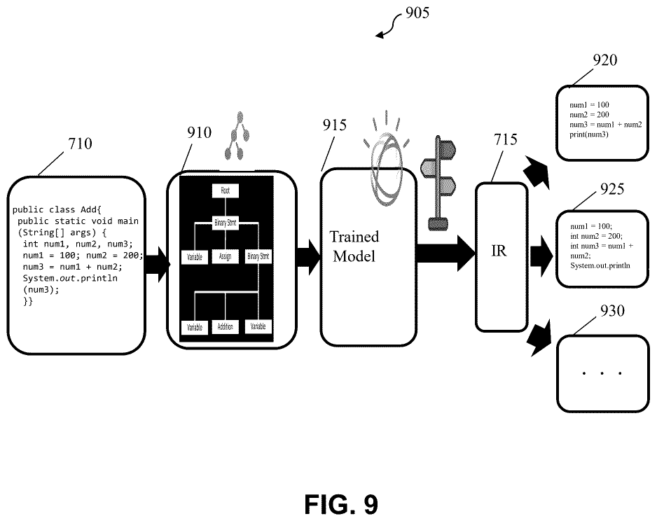

FIG. 9 shows a block diagram of deploying a reinforcement agent in accordance with aspects of the present invention. In FIG. 9, the block diagram 905 includes the at least one source code 710, an abstract syntax tree (AST) 910, a trained reward model 915, the intermediate representation (IR) 715, a first target code 920, a second target code 925, and a third target code 930. In the block diagram 905, the deploying module 216 utilizes a compiler to convert the at least one source code 710 into the AST 910. The deploying module 216 utilizes the trained reward model 915 on the AST 910 to guide the optimization process to output a target value of the reward function. The deploying module 216 utilizes the compiler with the intermediate representation (IR) on the target value of the reward function to output at least one target code. In embodiments of FIG. 9, the at least one target code comprises the first target code 920, the second target code 925, and the third target code 930.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving at least one source code from an external application;
computing a first code readability associated with the at least one source code and a first code complexity associated with the at least one source code and a second code readability associated with an intermediate code and a second code complexity of an intermediate code;
building a reward model based on the first code readability and the first code complexity of the at least one source code and the second code readability and the second code complexity of the intermediate code;
training the reward model by utilizing a reinforcement learning (RL) algorithm;
translating the at least one source code by utilizing a code compiler and the trained reward model; and
outputting at least one target code based on the translated at least one source code.

2. The method of claim 1, wherein the external application comprises a software application.

3. The method of claim 1, wherein the intermediate code is generated based on an intermediate representation (IR) of the at least one source code.

4. The method of claim 3, wherein the IR is part of the code compiler.

5. The method of claim 1, wherein the first code readability and the second code readability are based on a set of code readability metrics.

6. The method of claim 5, wherein the set of code readability metrics are determined by a convolutional neural network (CNN).

7. The method of claim 1, wherein the first code complexity and the second code complexity are based on a set of code complexity metrics.

8. The method of claim 7, wherein the set of code complexity metrics comprise a McCabe metric, a Halstead metric, and a cohesion metric.

9. The method of claim 1, wherein the reward model is built based on a reward function which subtracts a weighted average of the first code complexity and the second code complexity from the weighted average of the first code readability and the second code readability.

10. The method of claim 1, wherein the RL algorithm utilizes a reinforcement agent to take actions in an environment, wherein the actions in the environment are interpreted into the reward function and a state such that the reward function and the state are fed back to the reinforcement agent.

11. The method of claim 1, wherein the at least one target code comprises optimized code which is optimized for the first code readability, the second code readability, the first code complexity, and the second code complexity.

12. A computer program product comprising:
one or more computer readable storage media; and
program instructions stored on the one or more computer readable storage media to perform operations comprising:
receiving at least one source code from an external application;
computing a first code readability and a first code complexity of the at least one source code and a second code readability and a second code complexity of an intermediate code;
building a reward model based on the first code readability and the first code complexity of the at least one source code and the first code readability and the first code complexity of the intermediate code;
training the reward model by utilizing a reinforcement learning (RL) algorithm;
translating the at least one source code by utilizing a code compiler and the trained reward model; and
outputting at least one target code based on the translated at least one source code.

13. The computer program product of claim 12, wherein the intermediate code is generated based on an intermediate representation (IR) of the at least one source code.

14. The computer program product of claim 13, wherein the IR is part of a code compiler.

15. The computer program product of claim 12, wherein the first code readability and the second code readability are based on a set of code readability metrics.

16. The computer program product of claim 15, wherein the set of code readability metrics are determined by a convolutional neural network (CNN).

17. The computer program product of claim 12, wherein the first code complexity and the second code complexity are based on a set of code complexity metrics.

18. The computer program product of claim 17, wherein the set of code complexity metrics comprise a McCabe metric, a Halstead metric, and a cohesion metric.

19. The computer program product of claim 12, wherein the at least one target code comprises optimized code which is optimized for the first code readability, the second code readability, the first code complexity, and the second code complexity.

20. A system comprising:
a processor set;
one or more computer readable storage media; and
program instructions stored on the one or more computer readable storage media to cause the processor set to perform operations comprising:
receiving at least one source code from an external application;
computing a first code readability and a first code complexity of the at least one source code and a second code readability and a second code complexity of an intermediate code;
building a reward model based on the first code readability and the first code complexity of the at least one source code and the second code readability and the second code complexity of the intermediate code;
training the reward model by utilizing a reinforcement learning (RL) algorithm;
translating the at least one source code by utilizing a code compiler and the trained reward model; and
outputting at least one target code based on the translated at least one source code,
wherein the at least one target code comprises optimized code which is optimized for the first code readability, the second code readability, the first code complexity, and the second code complexity.
